(19) United States
(12) Patent Application Publication
(10) Pub. No.: US 2025/0166943 A1
(43) Pub. Date: May 22, 2025

(54) PRESS-INPUT DEVICE

(71) Applicant: ALPS ALPINE CO., LTD., Tokyo (JP)

(72) Inventors: Katsutoshi USUI, Miyagi (JP); Hiroshi OHARA, Miyagi (JP)

(21) Appl. No.: 19/033,048

(22) Filed: Jan. 21, 2025

Related U.S. Application Data
(63) Continuation of application No. PCT/JP2023/008753, filed on Mar. 8, 2023.

(30) Foreign Application Priority Data
Sep. 16, 2022 (JP) 2022-148562

(51) Int. Cl. H01H 13/14; H01H 3/38

(52) U.S. Cl. CPC H01H 13/14; H01H 3/38

(57) ABSTRACT

A press-input device includes: a substrate including an installation surface; and a click-spring member installed on the installation surface. The click-spring member includes: an annular skirt portion extending from an outer annular edge toward an inner annular projection at a first angle upward from the installation surface; and an inverting portion including an annular reinforcing plate extending from the inner annular projection toward an inner annular recess at a second angle smaller than the first angle, and a dome portion extending inwardly of the annular recess and projecting upward from the annular recess. The dome portion has a trapezoidal cross section and includes an annular slope portion extending inwardly and upwardly of the annular recess at a third angle greater than the second angle, and a top surface inwardly extending from an annular upper end of the annular slope portion and configured to receive a pressing force from above.

### CROSS-REFERENCE TO RELATED APPLICATIONS

This application is a continuation application of International Application No. PCT/JP2023/008753, filed on Mar. 8, 2023, and designated the U.S., which is based upon and claims priority to Japanese Patent Application No. 2022-148562, filed on Sep. 16, 2022, the entire contents of which are incorporated herein by reference.

### BACKGROUND

### 1. Field of the Invention

The present invention relates to a press-input device.

### 2. Description of the Related Art

The following Japanese Laid-Open Patent Application No. 2002-216580 discloses a disk contact plate which is capable of providing a click feeling to an operator by inverting a dome portion of the contact plate.

### SUMMARY

A press-input device according to an embodiment is provided with a substrate including an installation surface and a click-spring member installed on the installation surface. The click-spring member includes an annular skirt portion extending from an outer annular edge toward an annular projection, the annular projection being inward relative to the outer annular edge, at a first angle upward from the installation surface, and an inverting portion including an annular reinforcing plate extending from the annular projection toward an inner annular recess at a second angle smaller than the first angle and a dome portion extending inwardly of the annular recess and projecting upward from the annular recess. The dome portion has a trapezoidal cross section and includes an annular slope portion extending inwardly and upwardly of the annular recess at a third angle greater than the second angle, and a top surface inwardly extending from an annular upper end of the annular slope portion and configured to receive a pressing force from above. The second angle is within a range from 0° to 6° and the third angle is within a range from 18° to 23°.

### BRIEF DESCRIPTION OF THE DRAWINGS

FIG. 1 is a side sectional view of the press-input device according to one embodiment of the present disclosure;

FIG. 2 is a figure for explaining movement of the click-spring member provided in the press-input device according to the embodiment;

FIG. 3A is a graph for explaining reactive force properties of the click-spring member according to the embodiment;

FIG. 3B is a graph for explaining the reactive force properties of a click-spring member according to an existing technique;

FIG. 4A is a graph for explaining movement of the click-spring member according to the embodiment;

FIG. 4B is a graph for explaining movement of the click-spring member according to the existing technique; and

FIG. 5 is a figure illustrating an example of a preferable design of the click-spring member according to the embodiment.

### DETAILED DESCRIPTION OF THE DISCLOSURE

However, in the technique of Japanese Laid-Open Patent Application No. 2002-216580, since the cross-sectional shape of the dome portion of the contact plate is a general bowl shape, it is difficult to adjust an operation distance (that is, an amount of movement at the start of inverting) of the dome portion in a direction of shortening.

One embodiment will be described in the following with reference to the drawings. In the following description, for convenience, a Z-axis direction in the figures is defined as a vertical direction, a Y-axis direction in the figures is defined as a lateral direction, and an X-axis direction in the figures is defined as a front-rear direction. However, a Z-axis positive direction is defined as an upward direction, the Y-axis positive direction is defined as a rightward direction, and an X-axis positive direction is defined as a forward direction.

### (Configuration of Press-Input Device 100)

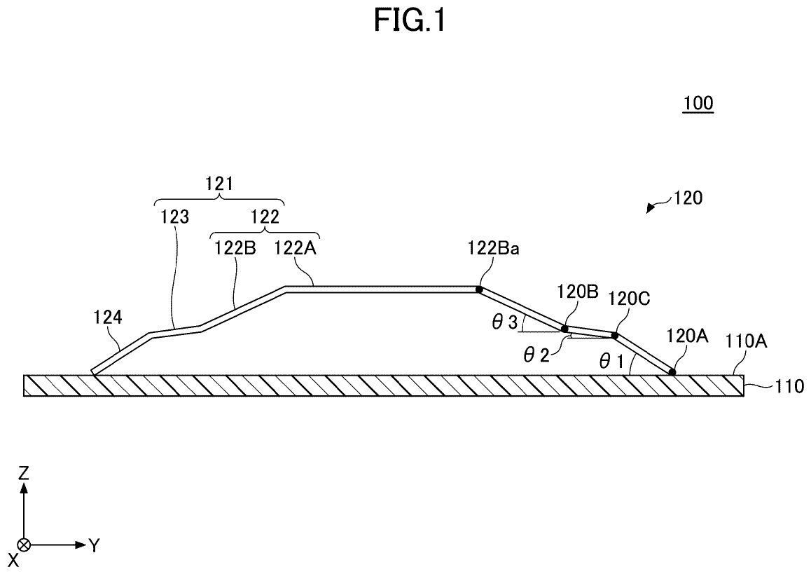

FIG. 1 is a side cross-sectional view of a press-input device 100 according to one embodiment. As illustrated in FIG. 1, the press-input device 100 includes a substrate 110 and a click-spring member 120.

The substrate 110 is a flat plate member made of a resin. An upper surface of the substrate 110 is an installation surface 110A on which the click-spring member 120 is installed.

The click-spring member 120 is a metal disk member installed on the installation surface 110A of the substrate 110. The click-spring member 120 has a dome shape projecting upward (in the Z-axis positive direction). The click-spring member 120 has a circular shape in a top view.

The click-spring member 120 includes an annular edge 120A which is an outer peripheral edge having a circular shape in the top view, and is installed on the installation surface 110A such that an entire area of the annular edge 120A contacts the installation surface 110A of the substrate 110.

As illustrated in FIG. 1, the click-spring member 120 includes the annular edge 120A, an annular projection 120C, an annular recess 120B, and an annular upper end 122Ba in order from the outside in a radial direction.

The annular edge 120A is a lower end and the outer peripheral edge of the click-spring member 120. The annular edge 120A has an annular shape in a top view.

The annular projection 120C has an annular shape in a top view and is a portion bent to project outward of the click-spring member 120.

The annular recess 120B has an annular shape in a top view and is a portion bent to recess inward of the click-spring member 120.

The annular upper end 122Ba is the upper end of the click-spring member 120 and is a portion bent to project outward of the click-spring member 120. The annular upper end 122Ba has an annular shape in a top view.

As illustrated in FIG. 1, the click-spring member 120 includes an inverting portion 121 and an annular skirt portion 124.

The inverting portion 121 includes a dome portion 122 and an annular reinforcing plate 123.

The dome portion 122 extends inwardly of the annular recess 120B and projects upward from the annular recess 120B. The dome portion 122 has a trapezoidal cross section and includes a top surface 122A and an annular slope portion 122B.

The top surface 122A is provided at the upper end of the click-spring member 120 and at the center of the click-spring member 120 in a top view, and is a horizontal flat portion having a circular shape. The top surface 122A extends inwardly of the annular upper end 122Ba of the annular slope portion 122B and receives a pressing force from above.

The annular slope portion 122B is an annular portion provided externally of the top surface 122A in a top view. The annular slope portion 122B is an inclined surface inclined at a predetermined inclination angle such that the radius gradually increases toward the outside in the radial direction. The annular slope portion 122B extends inwardly and upwardly of the annular recess 120B at a third angle θ3 greater than a second angle θ2. The upper end of the annular slope portion 122B is the annular upper end 122Ba.

The annular reinforcing plate 123 is an annular portion provided outside the annular slope portion 122B of the dome portion 122 in a top view. The annular reinforcing plate 123 is an inclined surface inclined at a predetermined inclination angle such that the radius gradually increases toward the outside in the radial direction. However, the inclination angle of the annular reinforcing plate 123 is gentler than that of the annular slope portion 122B. The annular reinforcing plate 123 extends from the annular projection 120C toward the inner annular recess 120B at the second angle θ2 smaller than a first angle θ1.

The annular skirt portion 124 is an annular portion provided outside the inverting portion 121 in a top view. The annular skirt portion 124 is an inclined surface inclined at a predetermined inclination angle such that the radius gradually increases toward the outside in the radial direction. The annular skirt portion 124 extends from the outer annular edge 120A toward the inner annular projection 120C at the first angle θ1 upward with respect to the installation surface 110A. The lower end of the annular skirt portion 124 is the aforementioned annular edge 120A.

The boundary between a lower end of the annular slope portion 122B and an upper end of the annular reinforcing plate 123 is the aforementioned annular recess 120B.

The boundary between a lower end of the annular reinforcing plate 123 and an upper end of the annular skirt portion 124 is the aforementioned annular projection 120C.

### (Movement of Click Spring Member 120)

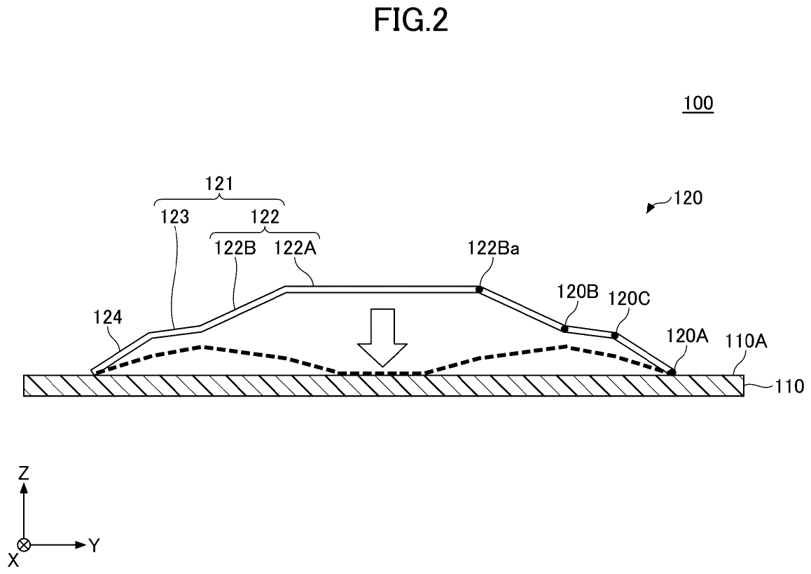

FIG. 2 is a figure for explaining movement of the click-spring member 120 provided in the press-input device 100 according to the embodiment. In FIG. 2, a state of the click-spring member 120 when pressing is not performed on the click-spring member 120 is illustrated by a solid line, and a state of the click-spring member 120 when the pressing is performed and the click-spring member 120 becomes inverted is illustrated by a dashed line.

In the click-spring member 120 according to the embodiment, when downward pressing is not performed on the top surface 122A, the dome portion 122 is in an initial state of upward projection, as illustrated by a solid line in FIG. 2. Therefore, while the annular edge 120A of the click-spring member 120 is in contact with the installation surface 110A of the substrate 110, the top surface 122A is not in contact with the installation surface 110A of the substrate 110.

According to the click-spring member 120 of the embodiment, when the downward pressing is performed on the top surface 122A, the top surface 122A moves downward while being elastically deformed to be entirely compressed.

Furthermore, in the click-spring member 120 according to the embodiment, when an operation load of the downward pressing on the top surface 122A exceeds a predetermined threshold value (that is, when a stroke amount of the top surface 122A exceeds a predetermined amount), the dome portion 122 elastically deforms into a recessed shape (inverts), as illustrated by the dashed line in FIG. 2. As a result, a backside portion of the top surface 122A contacts the installation surface 110A of the substrate 110.

At this time, the click-spring member 120 according to the embodiment can provide a click feeling to an operator of the top surface 122A because the operation load of the downward pressing on the top surface 122A is rapidly reduced by the inversion of the dome portion 122.

In the click-spring member 120 according to the embodiment, when the downward pressing on the top surface 122A is released, the dome portion 122 returns to its original upwardly-projecting dome shape by its own elastic force.

The press-input device 100 according to the embodiment may further be provided with a fixed contact member that always contacts the annular edge 120A and a movable contact member that contacts the top surface 122A during the pressing, on the installation surface 110A of the substrate 110. Thus, the press-input device 100 according to the embodiment can be used as a push switch that switches to a switched-on state when the top surface 122A is pressed.

### Comparative Example

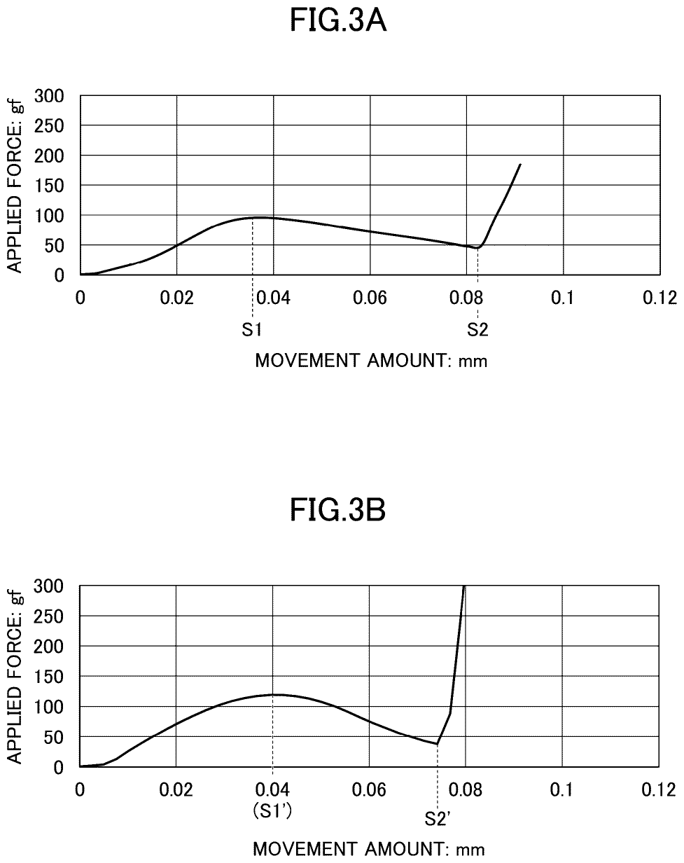

FIGS. 3A and 3B are graphs to compare reactive force properties between the click-spring member according to the embodiment and a click-spring member according to an existing technique. FIG. 3A is a graph illustrating an example of the reactive force properties of the click-spring member according to the embodiment. FIG. 3B is a graph illustrating an example of the reactive force properties of the click-spring member according to an existing technique. In FIGS. 3A and 3B, a vertical axis indicates an applied force [gram-force (gf)], and a horizontal axis indicates a movement amount [millimeter (mm)] of the click-spring member when pressed.

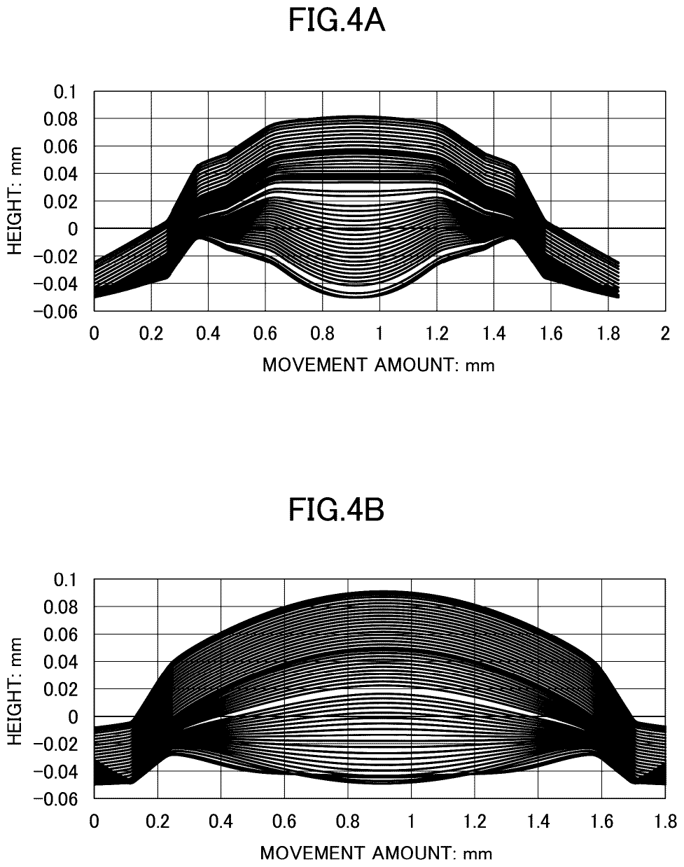

FIGS. 4A and 4B are graphs to compare movements of the click-spring member between the click-spring member 120 according to the embodiment and the click-spring member that uses the existing technology. FIG. 4A illustrates an example of the movement of the click-spring member 120 according to the embodiment. FIG. 4B illustrates an example of the movement of the click-spring member that uses the existing technology. In FIGS. 4A and 4B, the vertical axis indicates the height [mm] of the click-spring member, and the horizontal axis indicates a movement amount [mm] of the click-spring member.

In this comparative example, as the click-spring member 120 according to the embodiment, the click-spring member 120 having a trapezoidal cross-sectional shape of the dome portion 122 is used as described in FIG. 1. In this comparative example, as the click-spring member that uses the existing technology, a click-spring member having a cross section of a general bowl shape as disclosed in Japanese Laid-Open Patent Application No. 2002-216580, etc., is used.

As illustrated in FIG. 3A, in the click-spring member 120 according to the embodiment, when the top surface 122A of the dome portion 122 is pushed downward, a reactive force increases until a movement amount of the click-spring member 120 starting to become inverted from the initial state reaches a movement amount S1, the reactive force decreases from the movement amount S1 at the start of the inversion to a movement amount S2 at the end of the inversion, and the reactive force increases after reaching the movement amount S2 at the end of the inversion (i.e., in a state of overstroke).

Similarly, as illustrated in FIG. 3B, in the click-spring member that uses the existing technique, when the top portion of the dome portion is pushed downward, the reactive force increases until a movement amount of the click-spring member starting to become inverted from the initial state reaches a movement amount S1′, the reactive force decreases from the movement amount S1′ at the start of the inversion to a movement amount S2′ at the end of the inversion, and the reactive force increases after reaching the movement amount S2′ at the end of the inversion (i.e., in a state of overstroke).

Here, in the click-spring member 120 according to the embodiment, since the cross-sectional shape of the dome portion 122 is trapezoidal, the movement amount S1 at the start of the inversion of the dome portion 122 and the movement amount S2 at the end of the inversion of the dome portion 122 can be adjusted.

For example, in the click-spring member 120 according to the embodiment, since the cross-sectional shape of the dome portion 122 is trapezoidal, it is possible to enhance the rigidity of a peripheral portion of the dome portion 122, and therefore, as illustrated in FIGS. 3A and 3B, the movement amount S1 at the start of the inversion of the dome portion 122 can be made smaller than the movement amount S1′ at the start of the inversion of the dome portion in the click-spring member of the existing technique.

At this time, as illustrated in FIGS. 3A and 3B, the click-spring member 120 according to the embodiment can make the applied force at the movement amount S1 at the start of the inversion of the dome portion 122 approximately equal to the applied force at the movement amount S1′ at the start of the inversion of the dome portion 122 of the existing technique.

In the click-spring member 120 according to the embodiment, since the cross-sectional shape of the dome portion 122 is trapezoidal, as illustrated in FIGS. 3A and 3B, a reduction rate of the applied force of the dome portion 122 from the movement amount S1 at the start of the inversion to the movement amount S2 at the end of the inversion can be made gentler than the reduction rate of the applied force of the click-spring member of the existing technique from the movement amount S1′ at the start of the inversion operation to the movement amount S2′ at the end of the inversion.

As a result, the click-spring member 120 according to the embodiment can reduce the speed of the inversion of the dome portion 122, thereby reducing the contact noise with the substrate 110 at the time of the inversion of the dome portion 122.

In the click-spring member 120 according to the embodiment, since the cross-sectional shape of the dome portion 122 is trapezoidal, the movement amount S1 at the start of the inversion of the dome portion 122 and the movement amount S2 at the end of the inversion of the dome portion 122 can be adjusted to desired values while maintaining the applied force and the plate thickness by appropriately adjusting each parameter (a radius and an inclination angle of the top surface 122A and a radius and an inclination angle of the annular slope portion 122B) of the dome portion 122.

### (Example of Preferable Design)

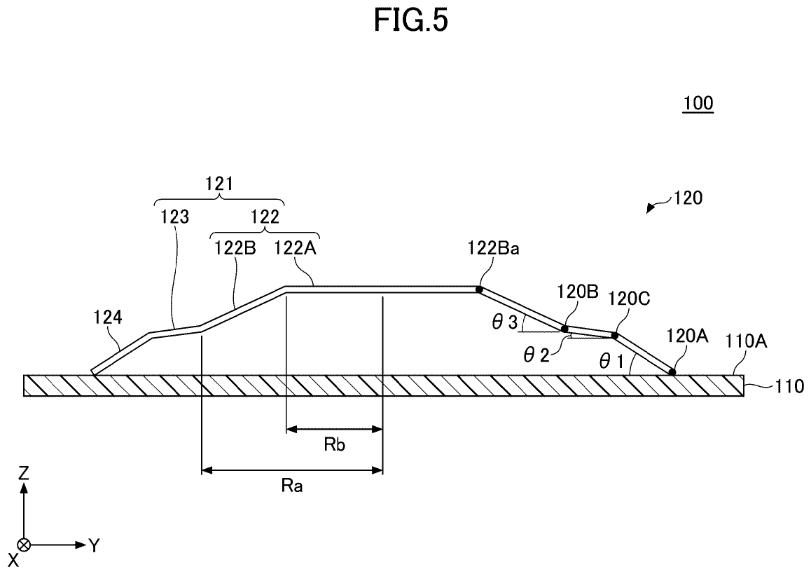

FIG. 5 is a figure illustrating an example of a preferable design of the click-spring member 120 according to the embodiment.

As illustrated in FIG. 5, when the inclination angle of the annular reinforcing plate 123 is set to the second angle θ2 and the inclination angle of the annular slope portion 122B of the dome portion 122 is set to the third angle θ3, the second angle θ2 is preferably within a range from 0° to 6° and the third angle θ3 is preferably within a range from 18° to 23°. These values are preferable values obtained by simulation or the like by the inventors.

Thus, the press-input device 100 according to the embodiment can provide a suitable click feeling to the operator.

Also, as illustrated in FIG. 5, when the radius of the annular slope portion 122B of the dome portion 122 is Ra and the radius of the top surface 122A of the dome portion 122 is Rb, it is preferable that a value of Rb/Ra is within a range from 0.5 to 0.75. These values are suitable values obtained by simulation or the like by the inventors.

Thus, the press-input device 100 according to the embodiment can provide a suitable click feel to the operator.

According to the press-input device according to one embodiment, the operation distance of the dome portion can be adjusted in the direction of shortening.

Although one embodiment of the present invention has been described in detail above, the present invention is not limited to the embodiment, and various modifications or changes may be made within the scope of the gist of the present invention as described in the claims.

What is claimed is:

1. A press-input device, comprising:
a substrate including an installation surface; and
a click-spring member installed on the installation surface, wherein
the click-spring member includes
an annular skirt portion extending from an outer annular edge toward an annular projection, the annular projection being inward relative to the outer annular edge, at a first angle upward from the installation surface, and
an inverting portion including an annular reinforcing plate extending from the annular projection toward an inner annular recess at a second angle smaller than the first angle, and a dome portion extending inwardly of the annular recess and projecting upward from the annular recess,
the dome portion has a trapezoidal cross section and includes an annular slope portion extending inwardly and upwardly of the annular recess at a third angle greater than the second angle, and a top surface inwardly extending from an annular upper end of the annular slope portion and configured to receive a pressing force from above,
the second angle is within a range from 0° to 6°, and
the third angle is within a range from 18° to 23°.

2. The press-input device according to claim 1, wherein
when a radius of the annular slope portion is Ra, and a radius of the top surface is Rb, a value of Rb/Ra is within a range from 0.5 to 0.75.
